(19) United States
(12) Patent Application Publication
(10) Pub. No.: US 2008/0077704 A1
(43) Pub. Date: Mar. 27, 2008

(54) Variable Electronic Communication Ping Time System and Method

(75) Inventors: Amit Jindas Shah, Livonia, MI (US); Joseph Collins, Darien, CT (US)

Correspondence Address: DOWNS RACHLIN MARTIN PLLC, 199 MAIN STREET, P O BOX 190, BURLINGTON, VT, 05402-0190, US

(73) Assignee: VOID COMMUNICATIONS, INC., Darien, CT (US)

(21) Appl. No.: 11/859,777

(22) Filed: Sep. 23, 2007

Related U.S. Application Data
(60) Provisional application No. 60/826,743, filed on Sep. 24, 2006.

(51) Int. Cl. G06F 15/16

(52) U.S. Cl. 709/233

(57) ABSTRACT

A computer-implemented system and method of requesting data from a remote computer having a ping series for a data request that has ping delay time that varies from the initial ping delay time in the ping series to the final ping delay time in the series. In one example, the ping delay time from one ping delay to another in a ping series increases or decreases over the last ping delay time until a predetermined process event occurs.

### RELATED APPLICATION DATA

This application claims the benefit of priority of U.S. Provisional Patent Application Ser. No. 60/826,743, filed Sep. 24, 2006, and titled “Variable Electronic Communication Ping Time System and Method,” which is incorporated by reference herein in its entirety.

### FIELD OF THE INVENTION

The present invention generally relates to the field of electronic communications. In particular, the present invention is directed to a variable electronic communication ping time system and method.

### BACKGROUND

A network configuration (e.g., a typical web application) is generally not conducive to asynchronously receiving messages from a server. A client application may need to query the server at some fixed interval to check if any data (e.g., electronic messages) are present for the particular client application. A problem exists in balancing between server and network performance and useability of the client application.

### SUMMARY OF THE DISCLOSURE

In one embodiment, a computer-implemented method of requesting data from a remote computer is provided. The method includes transmitting a ping request for data to the remote computer; and automatically successively transmitting additional ping requests for data to the remote computer spaced by time delays that vary according to a predetermined function from one successive time delay to another until a predetermined process event occurs.

In another embodiment, a computer-implemented method of requesting data from a remote computer potentially having data for access by another computer is provided. The method includes initiating a ping series to the remote computer for accessing data from the remote computer, the ping series including a plurality of ping attempts each spaced by a ping time delay; automatically increasing or decreasing the time of one or more of the ping time delays from an initial ping time delay across the ping series such that the ping time delay increases or decreases from the initial ping time delay over time; and resetting or terminating the ping series upon accessing data from the remote computer.

In yet another embodiment, a system for requesting data from a remote computer is provided. The system includes means for initiating a ping series to the remote computer for accessing data from the remote computer, the ping series including a plurality of ping attempts each spaced by a ping time delay; means for automatically increasing or decreasing the time of one or more of the ping time delays from an initial ping time delay across the ping series such that the ping time delay increases or decreases from the initial ping time delay over time; and means for resetting or terminating the ping series upon accessing data from the remote computer.

In still yet another embodiment, a machine readable medium containing machine executable instructions implementing a method of requesting data from a remote computer is provided. The instructions include a set of instructions for transmitting a ping request for data to the remote computer; and a set of instructions for automatically successively transmitting additional ping requests for data to the remote computer spaced by time delays that vary according to a predetermined function from one successive time delay to another until a predetermined process event occurs.

In still yet another embodiment, a machine readable medium containing machine executable instructions implementing a method of requesting data from a remote computer is provided. The instructions include a set of instructions for initiating a ping series to the remote computer for accessing data from the remote computer, the ping series including a plurality of ping attempts each spaced by a ping time delay; a set of instructions for automatically increasing or decreasing the time of one or more of the ping time delays from an initial ping time delay across the ping series such that the ping time delay increases or decreases from the initial ping time delay over time; and a set of instructions for resetting or terminating the ping series upon accessing data from the remote computer.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary embodiment of a system for electronically communicating information;

FIG. 2 illustrates one exemplary embodiment of a method for requesting data from a remote computer;

FIG. 3 illustrates another exemplary embodiment of a method for requesting data from a remote computer; and

FIG. 4 illustrates one exemplary embodiment of a computing environment.

### DETAILED DESCRIPTION

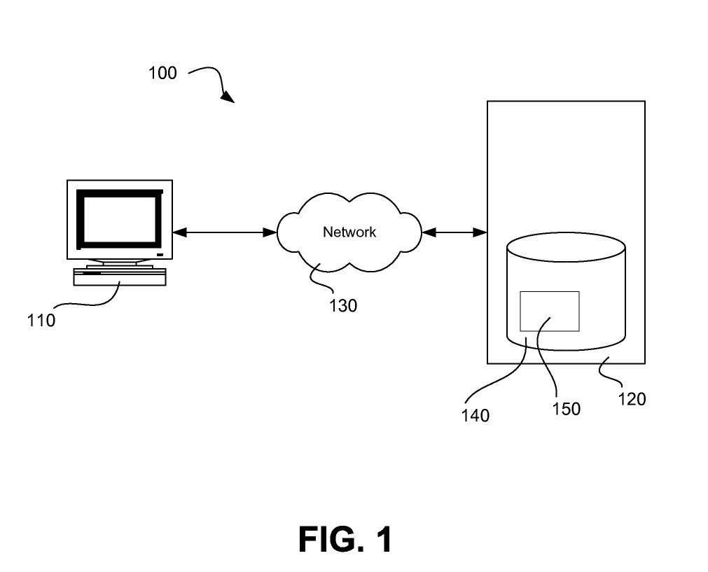

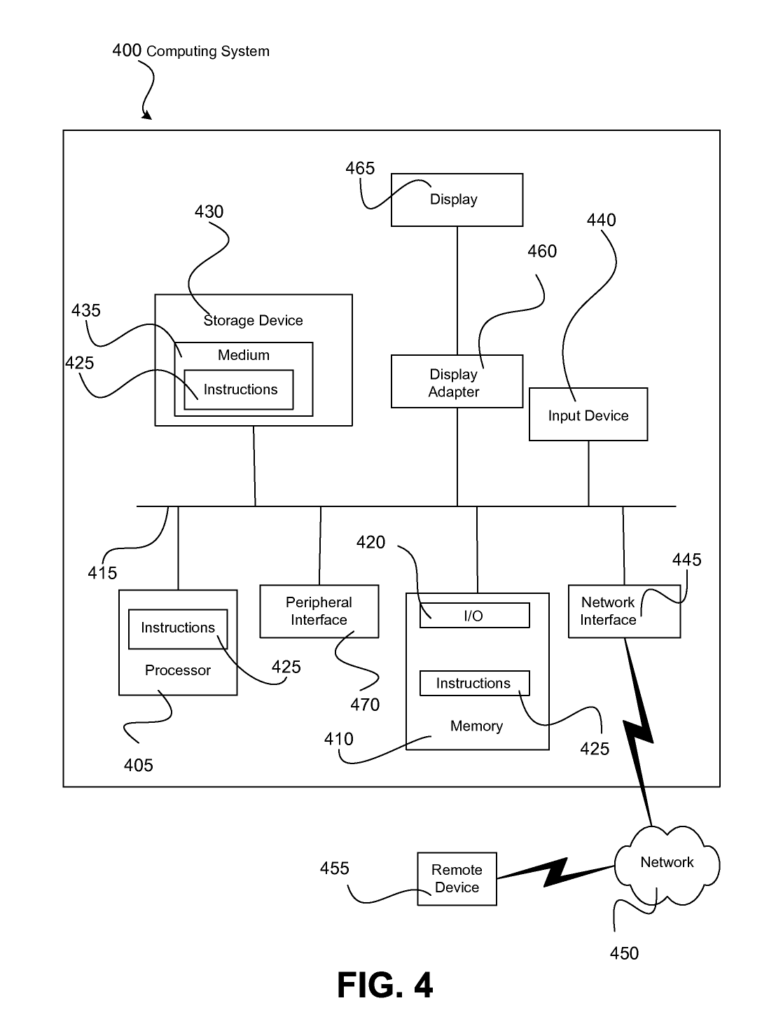

FIG. 1 illustrates an exemplary implementation of a system 100 for electronically communicating information. System 100 includes a computer 110 and a computer 120. Computers 110 and 120 are connected to a network 130 for allowing electronic communication between computers 110 and 120. Examples of a computer and exemplary networks are discussed further below with respect to FIG. 4. Computer 120 may include a machine-readable medium 140 for storing data 150 that may be accessed by computer 110. In one aspect, system 100 allows computer 110 to “ping” computer 120 using time delays between pings of a ping series that increase or decrease in time across the ping series.

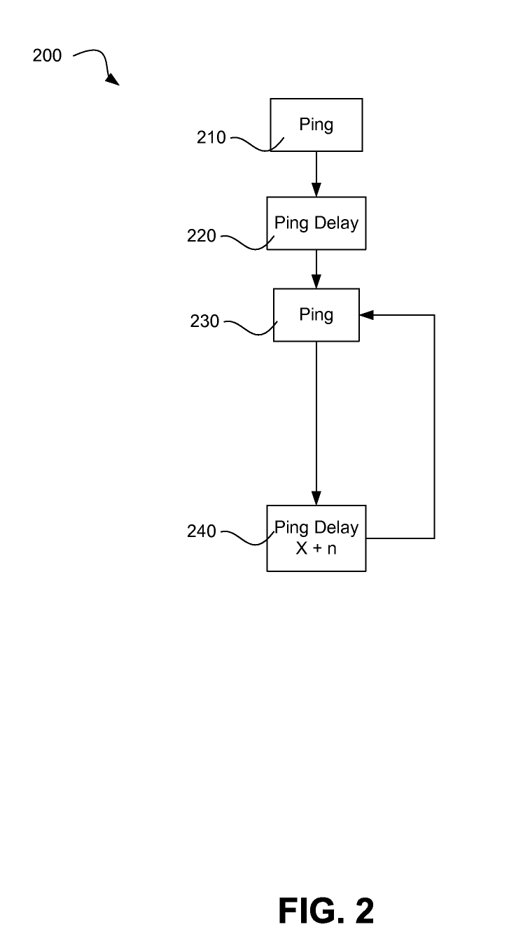

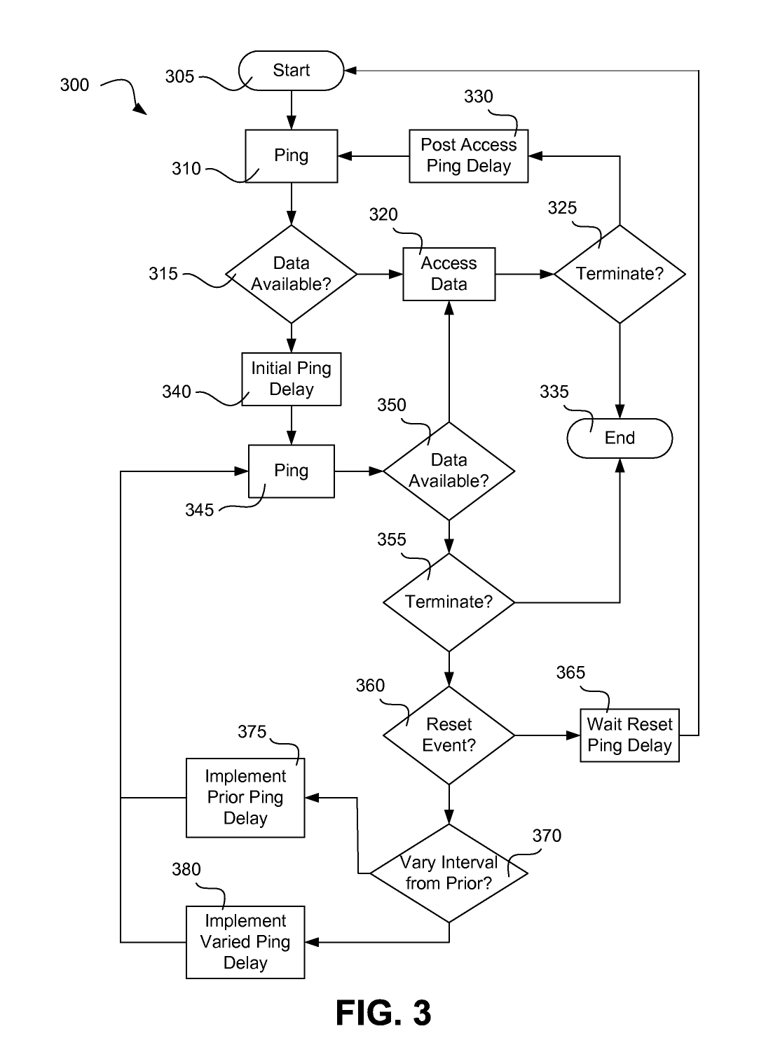

Certain general aspects of exemplary implementations of a system and method of requesting data from a remote computer will now be discussed with respect to system 100. Additional aspects of increasing and/or decreasing ping time delay over a ping series are discussed further below with respect to exemplary implementations set forth in FIGS. 2 and 3.

In certain situations, a permanent open communication channel between computer 110 and computer 120 (e.g., an open socket connection) may not be feasible, and computers 110 and 120 may need to reestablish a communication channel with each attempted electronic communication. Other situations also exist where a ping may be useful in communicating between computers. For example, in certain implementations computer 120 may not be able to open a connection with computer 110, but computer 110 may be able to open a connection with computer 120. A ping may include any request for opening of a communication channel and/or request for data between any one or more computers on a network. FIG. 1 shows two computers 110, 120. It is contemplated that any number of computers may be connected to network 130 for establishing electronic communication therebetween. In one example, one computer (e.g., computer 110) may transmit over network 130 any one or more pings at a time individually and/or in combination to any one or more remote computers.

One example of an electronic communication environment in which one computer makes periodic requests for data from another computer is known as a “pull” communication environment. In a pull environment, one computer transmits periodic pings to one or more other computers requesting data. If data is available on the one or more other computers, that data may be accessed by the first computer. If data is unavailable, the connection between the computers may be relinquished with the first computer transmitting another ping after a ping time delay.

A series of pings may be communicated from computer 110 to computer 120, with each of the pings separated by a time delay. As discussed above, each ping may include a request for data 150 that may be stored in a memory 140. Examples of data 150 include, but are not limited to, an electronic message (e.g., an email, a recordless electronic message, XML, SOAP), information representing a listing of electronic messages stored on computer 120, other data and any combinations thereof. Exemplary recordless electronic message systems and methods are set forth in U.S. Patent Application Publication No. 2007/0038715A1, published on Feb. 15, 2007, which is incorporated herein by reference in its entirety. Data 150 may be stored in a variety of forms in memory 140. For example, data 150 may be stored in a table, a database, a chart, a listing, an electronic messaging format, and any combinations thereof.

During a connection between computer 110 and 120 (e.g., an electronic connection instigated by a ping), data may be accessed between computer 110 and 120. In one example, data stored on computer 120 may be accessed by computer 110. In another example, data stored on computer 110 may be accessed by computer 120. In one example, if data (e.g., new data that has not been previously accessed by computer 110) is not available, computer 120 may send an electronic indication of the lack of data to computer 110. In another example, if data is not available, computer 120 may not respond and the lack of response may be interpreted by computer 110 as an indication of the lack of data. Typically, a ping series will continue when no data is available for access.

Data on one computer may be accessed by another computer in a variety of ways. Examples of ways of access include, but are not limited to, reading data, downloading data, using data, opening data, processing data, storing data, and any combinations thereof. In one example, computer 120 may include (or have associated therewith) a web server and computer 110 may utilize a web browser to access data stored on computer 120. In accessing data on computer 120, computer 110 may also transfer data to computer 120. After a ping and/or accessing of data, the connection between computer 110 and 120 may be relinquished.

In one alternative implementation, computer 120 may examine a ping request, information stored on computer 120 regarding prior data access, information communicated to computer 120 from computer 110 regarding prior data access, and/or other information to determine what data 150 stored in memory 140 may have already been accessed by computer 110. In one example, computer 110 may then access (e.g., have transmitted thereto, read directly from computer 120, etc.) data that has not yet been accessed. In one such example, computer 120 may transmit data representing only new electronic messages available on computer 120 to computer 110 (e.g., updating existing data on computer 110 that was previously accessed). Alternatively, computer 120 may provide access to all new and previously accessed data to computer 110. For example, computer 120 may transmit to computer 110 a complete updated list of available electronic messages (both new and previously accessed). Instructions for handling previously accessed data may be stored as settings including, but not limited to, a default setting, a user-defined condition, a setting influenced by one or more events on system 100, and any combinations thereof. Retention of data that has been accessed may be handled in a variety of ways. In one example, data that is accessed may be deleted from computer 120. In another example, data that is accessed may be deleted from computer 120 and computer 110 (e.g., after a user of computer 110 utilizes the data a set amount of times). In still another example, data that is accessed may be retained on computer 120 indefinitely. In yet another example, data that is accessed may be retained on computer 120 for a set amount of time after accessing.

In one exemplary implementation, computer 120 may act as an electronic message server and computer 110 may act as a user access computer to the electronic message server. In one example, computer 110 may transmit a plurality of pings to computer 120 to inquire as to new electronic messages that may be present on the message server. The time delay between pings increases or decreases as the ping series progresses without a response that new electronic messages are available for accessing.

As is discussed further below, one or more aspects of varying ping time delay may be implemented as machine-executable instructions. In one example, such instructions may be stored in a machine-readable medium associated with system 100. In another example, such instructions may be distributed across system 100 (e.g., across computers 110, 120), reside as part of a central controller (not shown) of system 100, downloaded from computer 120 to computer 110, and/or be stored and/or executed by any combination thereof. As discussed above, system 100 may be a web-based system. In one example, downloadable instructions (e.g., Javascript, JAVA, hypertext markup language) may be downloaded and/or processed from computer 120 to computer 110 (e.g., upon loading of a website) and executed to instigate a ping series from computer 110 to computer 120 requesting data.

FIG. 2 illustrates one embodiment of a method 200 of varying ping delay time in a ping series. At step 210 an initial ping of a ping series is transmitted. At step 220, method 200 waits for an initial time corresponding to an initial ping delay prior to transmitting a subsequent ping at step 230.

At step 240, the time of ping delay for subsequent ping delays is increased or decreased over a prior ping delay time. It is contemplated that variance of ping delay in a ping series includes varying every subsequent ping delay in a series and leaving a number of adjacent ping delays in a series at the same time while varying the ping delay as the ping series progresses. In one example (as shown in FIG. 2), each subsequent ping delay time is increased or decreased over the immediately prior ping delay time in a ping series. In another example, a plurality of adjacent ping delay times in a series are held the same and ping delay time is increase or decreased between each plurality of adjacent ping delay times in the series (e.g., an initial ping delay time of 5 minutes followed by two subsequent ping delay times of 5 minutes, three subsequent ping delay times of 7.5 minutes, three subsequent ping delay times of 10 minutes, and so on).

An increase or decrease in ping delay time may be viewed as a function of a prior ping delay time in a series and a ping delay variance:

Current ping delay time=X+N,

where X represents the prior ping delay time in the series and N represents a positive or negative ping delay variance.

N may be any mathematical function or algorithm for automatically successively decreasing or increasing a ping delay time in a ping series. N may depend on a variety of factors including, but not limited to a predetermined default algorithm, a user-defined algorithm, a function of resource load on the pinging computers, a function of resource load on one or more pinged computers, a function of time of day, the existence of data for retrieval on one or more pinged computers, a maximum amount of time in ascending variation, a minimum amount of time in descending variation, and any combinations thereof. N may represent a variety of functions including, but not limited to a linear function, an exponential function, a parabolic function, a random function, a wave function (e.g., a sinusoidal function), and any combinations thereof.

In one example, N may be zero time for one or more determinations of current ping delay time in a ping series as long as the ping delay time increases or decreases over the length of the ping series. In another example, N may depend on a function that returns a time value that is different at different calculations throughout a given ping series.

After implementation of a varied ping delay time at step 240, method 200 proceeds to step 230 for transmitting another subsequent ping.

Rules representing values for initial ping delay time, instructions for determining ping delay variance, instructions for determining process conditions (e.g., system loads), and any combinations thereof may be stored in one or more memory elements associated with one or more computers (e.g., computer 110, 120 of FIG. 1) involved with electronic communications related to a ping series.

Method 200 may include elements that are blocking or non-blocking to other processes being executed by a pinging computer and/or one or more pinged computers. A blocking process takes priority over other processes and may block the execution of the other processes for a time on a computer. A non-blocking process allows other functions to continue their execution on one or more computers.

Although not shown in FIG. 2, a ping series may be interrupted by one or more process events that occur with relation to the electronic communication and/or one or more computer/network elements associated therewith. Examples of a process event include an accessing of data, a terminating event, and a reset event. As discussed above, a pinging computer (e.g., computer 110) may access data on a pinged computer (e.g., computer 120). In one example, a ping series may reset to an initial ping delay time upon accessing of data. In another example, a ping series may continue with the prior increasing/decreasing ping series after accessing of data.

A terminating event is an event that brings a method of requesting data to an end. Examples of a terminating event include, but are not limited to, a user deciding to end the process, a loss of network connection, and any combinations thereof.

A reset event is an event that instigates a reset of a method of varying ping delay time in a ping series to a new ping series with a starting initial ping delay time. Examples of a reset event include, but are not limited to, existence of data to be accessed on pinged computer, a requirement of a data acquisition application, a predetermined number of ping and delay cycles, a user defined number of ping and interval cycles, a business rule, reaching a maximum ping delay time (e.g., in an ascending delay ping series, reaching a minimum ping delay time (e.g., in a descending delay ping series), and any combinations thereof. In one example, maximum and/or minimum ping delay times may be a function of a variety of factors including, but not limited to, a user-defined number, a predetermined number, input of a system condition (e.g., server load), and any combinations thereof.

In one example, after making an initial ping, a pinging computer may delay making a subsequent ping for 5 seconds. If after making the subsequent ping there is no data available for access on one or more pinged computers, the pinging computer waits 7.5 seconds prior to sending a subsequent ping. If after making this subsequent ping, the pinging computer waits 10 seconds prior to sending an additional subsequent ping. This linear variation may continue with 2.5 second variations to the ping delay time until a predetermined process event occurs (e.g., the ping series may reset to a 5 second ping delay after reaching a maximum delay time, such as 5 minutes).

FIG. 3 illustrates another exemplary implementation of a method 300 for requesting information from a remote computer. At step 310, an initial ping request of a ping series is submitted to one or more remote computers.

At step 315, it is determined whether data for accessing by an access computer is available on the one or more remote computers. If data is available for access, the access computer may access the data at step 320. At step 325, an optional termination process determines if one or more termination conditions exist. If a termination condition exists, method 300 ends at 335. If a termination condition does not exist (or a termination process 325 is not part of method 300), method 300 may wait at step 330 for an amount of time corresponding to a post access ping delay prior to returning to step 310 to submit an initial ping request of a new ping series to the one or more remote computers.

If at step 315 no data is available for access, method 300 proceeds to step 340 to wait an initial ping delay time prior to submitting a ping request at step 345.

In an alternative embodiment, method 300, after allowing access to data on the one or more remote computers at step 320, may proceed to step 340 and wait for an initial ping delay time prior to submitting a ping request at step 345.

At step 350, it is determined whether data for accessing by the access computer is available on the one or more computers. If data is available for access, the access computer may access the data at step 320, as discussed above. If data is not available for access, method 300 may include an optional step 355 at which a termination process determines if one or more termination conditions exist. If a termination condition exists, method 300 ends at 335. If a termination condition does not exist (or a termination process 355 is not part of method 300), method 300 proceeds to an optional reset step 360.

At step 360 an optional reset process determines if one or more reset events have occurred. If a reset event has occurred, method 300 may wait at step 365 a time corresponding to a reset delay prior to returning to step 310 to submit an initial ping request of a new ping series to the one or more remote computers. If a reset event has not occurred (or a reset process 360 is not part of method 300), method 300 may proceed to an optional delay variance decision step 370.

At optional step 370, a delay variance decision process determines whether a subsequent ping delay should be the same as a prior ping delay or if it should vary according to a predetermined function. A delay variance decision process may be driven by a pattern and/or function (e.g., stored in a memory) that instructs when in a ping series to have adjacent ping delays remain with the same timing. In one example, a delay variance decision process may determine that a subsequent ping delay should be the same as an immediately preceding ping delay where the variance in ping delay times of a ping series has a plurality of ping delays at the same amount of delay prior to varying (e.g., increasing or decreasing) the delay time. In one such example, a first ping delay may be 5 minutes, a second ping delay may be 5 minutes, a third ping delay may vary to 6 minutes, a fourth ping delay may be 6 minutes, a fifth ping delay may be 7 minutes, a sixth ping delay may be 7 minutes, and so on. If the delay variance decision process determines that the next ping delay should be the same as a prior ping delay, method 300 proceeds to step 375 to wait an amount of time corresponding to a ping delay that is the same as the prior ping delay in the ping series. If the delay variance decision process determines that the next ping delay should be varied from the prior ping delay in the ping series (or if a delay variance decision process 370 is not part of method 300), method 300 proceeds to step 380. In one example, a delay variance decision process may be built into the predetermined function that is used to determine the variance in ping delay time. For example, an algorithm for N may include allowing ping delays that are adjacent to each other in a ping series to remain the same while increasing or decreasing the ping delay time across the ping series.

At step 380, method 300 waits an amount of time corresponding to a varied ping delay that is different from a prior ping delay in the ping series prior to submitting a subsequent ping to the remote computer at step 345. Method 300 continues as discussed above.

Step 350 and optional steps 355, 360 each determine the existence of process events that may end a given ping series and the corresponding variance in ping delay (e.g., by terminating method 300, by resetting method 300 to step 310). It is also contemplated that step 350 and any of optional steps 355, 360, 370 may alternatively occur (if present) in a variety of orders. For example, a delay variance decision process (e.g., step 370) may occur prior to a reset process (e.g., step 360). In one such example, a decision to increment a ping delay to a new varied ping delay time may represent a reset event.

In one or more of the examples provided herein, network traffic may be reduced between two computers and on the overall network. Additionally, computing power of a pinged computer may be reduced resulting in less power consumption and more efficient operation of a system including a pinging and pinged computer. In another aspect, an exemplary system and method may allow for a pinged computer to accept more of a load while providing a pinging computer with reasonable performance capability. In such an example, a pinging computer may be served quickly by a pinged computer when a ping series has smaller ping delays while also minimizing system load when a ping series has larger ping delays. In another aspect, an exemplary system may be able to work well in communicating where the included computers may not be able to have a constant connection.

It is to be noted that the aspects and embodiments described herein may be conveniently implemented using one or more machines (e.g., a computer) programmed according to the teachings of the present specification, as will be apparent to those of ordinary skill in the computer art. For example, various aspects of a method for requesting data from one or more remote computers including a ping series having increasing or decreasing ping delay time as described herein, may be implemented as machine-executable instructions (i.e., software coding), such as program modules executed by one or more machines. Typically a program module may include routines, programs, objects, components, data structures, etc. that perform specific tasks. Appropriate machine-executable instructions can readily be prepared by skilled programmers based on the teachings of the present disclosure, as will be apparent to those of ordinary skill in the software art.

Such software may be a computer program product that employs a machine-readable medium. Example computer programs include, but are not limited to, an operating system, a browser application, a micro-browser application, a proxy application, a business application, a server application, an email application, an online service application, an interactive television client application, an ISP client application, a gateway application, a tunneling application, and any combinations thereof. A machine-readable medium may be any medium that is capable of storing and/or encoding a sequence of instructions for execution by a machine (e.g., a computer) and that causes the machine to perform any one of the methodologies and/or embodiments described herein. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as a collection of physically separate media, such as, for example, a collection of compact disks or one or more hard disk drives in combination with a computer memory.

Examples of a computer include, but are not limited to, a general purpose computer; a special purpose computer; a computer workstation; a terminal computer; a notebook/laptop computer; a server computer; a handheld device (e.g., tablet computer, a personal digital assistant “PDA”, a mobile telephone, etc.); a web appliance; a network router; a network switch; a network bridge; a set-top box “STB;” video tape recorder “VTR;” a digital video recorder “DVR;” a digital video disc “DVD” device (e.g., a DVD recorder, a DVD reader); any machine, component, tool, equipment capable of executing a sequence of instructions that specify an action to be taken by that machine, and any combinations thereof. In one example, a computer may include and/or be included in, a kiosk. In another example, a computing device includes a mobile device. In yet another example, a computing device includes a device configured for display of video and/or audio content accessed over a network.

FIG. 4 shows a diagrammatic representation of one embodiment of a machine in the exemplary form of a computer system 400 within which a set of instructions for causing the machine to perform any one or more of the aspects and/or methodologies of the present disclosure may be executed. It should be noted that although computer system 400 itself and its components may be shown as singular entities, each component and computer system 400 may include any number of components configured to perform a certain functionality. For example, multiple computer systems 400 may combine to perform any one or more of the aspects and/or methodologies of the present disclosure. Additionally any one aspect and/or methodology of the present disclosure may be dispersed across any number of computer system 400 or across any number of computer system components.

Computer system 400 includes a processor 405 and a memory 410 that communicate with each other, and with other components, via a bus 415. Bus 415 may include any of several types of bus structures including, but not limited to, a memory bus, a memory controller, a peripheral bus, a local bus, and any combinations thereof, using any of a variety of bus architectures.

Memory 410 may include various components (e.g., machine readable media) including, but not limited to, a random access memory component (e.g., a static RAM “SRAM”, a dynamic RAM “DRAM”, etc.), a read only component, and any combinations thereof. In one example, a basic input/output system 420 (BIOS), including basic routines that help to transfer information between elements within computer system 400, such as during start-up, may be stored in memory 410. Memory 410 may also include (e.g., stored on one or more machine-readable media) instructions (e.g., software) 425 embodying any one or more of the aspects and/or methodologies of the present disclosure. In another example, memory 410 may further include any number of program modules including, but not limited to, an operating system, one or more application programs, other program modules, program data, and any combinations thereof.

Computer system 400 may also include a storage device 430. Examples of a storage device (e.g., storage device 430) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 430 may be connected to bus 415 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 430 may be removably interfaced with computer system 400 (e.g., via an external port connector (not shown)). Particularly, storage device 430 and an associated machine-readable medium 435 may provide nonvolatile and/or volatile storage of machine-readable instructions, data structures, program modules, and/or other data for computer system 400. In one example, software 425 may reside, completely or partially, within machine-readable medium 435. In another example, software 425 may reside, completely or partially, within processor 405.

Computer system 400 may also include an input device 440. In one example, a user of computer system 400 may enter commands and/or other information into computer system 400 via input device 440. For example, a user may utilize a computer with an input device, such as input device 440 to access data from a remote computer. Examples of an input device 440 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 440 may be interfaced to bus 415 via any of a variety of interfaces (not shown) including, but not limited to, a serial interface, a parallel interface, a game port, a USB interface, a FIREWIRE interface, a direct interface to bus 415, and any combinations thereof.

A user may also input commands and/or other information to computer system 400 via storage device 430 (e.g., a removable disk drive, a flash drive, etc.) and/or a network interface device 445. A network interface device, such as network interface device 445 may be utilized for connecting computer system 400 to one or more of a variety of networks, such as network 450, and one or more remote computers 455 connected thereto. Examples of a network interface device include, but are not limited to, a network interface card, a modem, and any combination thereof. A network may include one or more elements configured to communicate data (e.g., direct data, deliver data). Examples of a network element include, but are not limited to, a router, a server, a switch, a proxy server, an adapter, an intermediate node, a wired data pathway, a wireless data pathway, a memory element, a processor, and any combinations thereof. Examples of a network or network segment include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 450, may employ a wired and/or a wireless mode of communication. Various communication protocols (e.g., HTTP, WAP, TCP/IP, UDP, ATM) and/or encryption protocols (e.g., SSL, TLS, IPSEC) may be utilized in connecting and/or for communication over a network, such as network 450. In general, any network topology may be used. Information (e.g., data, software 425, etc.) may be communicated to and/or from computer system 400 via network interface device 445. In yet another example, storage device 430 may be connected to bus 415 via network interface 445. In still another example, input device 440 may be connected to bus 415 via network interface 445.

Computer system 400 may further include a video display adapter 460 for communicating a displayable image to a display device, such as display device 465. For example, video display adapter 460 may be utilized to display an interface for accessing data from a remote computer to display device 465. Examples of a display device include, but are not limited to, a liquid crystal display (LCD), a cathode ray tube (CRT), a plasma display, and any combinations thereof. In addition to a display device, a computer system 400 may include one or more other peripheral output devices including, but not limited to, an audio speaker, a printer, and any combinations thereof. Such peripheral output devices may be connected to bus 415 via a peripheral interface 470. Examples of a peripheral interface include, but are not limited to, a serial port, a USB connection, a FIREWIRE connection, a parallel connection, and any combinations thereof.

A digitizer (not shown) and an accompanying pen/stylus, if needed, may be included in order to digitally capture freehand input. A pen digitizer may be separately configured or coextensive with a display area of display device 465. Accordingly, a digitizer may be integrated with display device 465, or may exist as a separate device overlaying or otherwise appended to display device 465.

Terms such as first, second, and third may be utilized herein to provide ease of distinction between elements and are not intended to designate any particular order or magnitude of relationship between the elements. Additionally, for the sake of brevity, certain aspects and embodiments are described herein as including a single element (e.g., a single computing element) or as including a plurality of elements (e.g., multiple databases for storing data elements). It is contemplated that single elements may include multiple elements and multiple elements as shown may be configured as a single element.

Exemplary embodiments have been disclosed above and illustrated in the accompanying drawing. It will be understood by those skilled in the art that various changes, omissions and additions may be made to that which is specifically disclosed herein without departing from the spirit and scope of the present invention.

What is claimed is:

1. A computer-implemented method of requesting data from a remote computer, the method comprising:
transmitting a ping request for data to the remote computer; and
automatically successively transmitting additional ping requests for data to the remote computer spaced by time delays that vary according to a predetermined function from one successive time delay to another until a predetermined process event occurs.

2. A method according to claim 1, wherein the predetermined function decreases the time delays between successively transmitted ping requests.

3. A method according to claim 1, wherein the predetermined function increases the time delays between successively transmitted ping requests.

4. A method according to claim 1, wherein said predetermined process event includes a process event selected from the group consisting of an accessing of data from the remote computer, a termination event, a reset event, and any combinations thereof.

5. A method according to claim 1, wherein said predetermined process event includes a time delay reaching a maximum or minimum time delay.

6. A method according to claim 5, further comprising:
resetting the time delay between additional successive ping requests to a time of an earlier time delay; and
continuing to vary the time delay between the additional successive ping requests by a predetermined function.

7. A method according to claim 1, further comprising accessing data from the remote computer.

8. A method according to claim 7, further comprising:
resetting the time delay between additional successive ping requests to a time of an earlier time delay; and
continuing to vary the time delay between the additional successive ping requests by a predetermined function.

9. A method according to claim 1, wherein the time delays between ping requests increase or decrease over time and at least two consecutive time delays between ping requests are the same time.

10. A computer-implemented method of requesting data from a remote computer potentially having data for access by another computer, the method comprising:
initiating a ping series to the remote computer for accessing data from the remote computer, the ping series including a plurality of ping attempts each spaced by a ping time delay;
automatically increasing or decreasing the time of one or more of the ping time delays from an initial ping time delay across the ping series such that the ping time delay increases or decreases from the initial ping time delay over time; and
resetting or terminating the ping series upon accessing data from the remote computer.

11. A method according to claim 10, wherein said resetting step includes initiating a new ping series having a new initial ping time delay that is the same as the initial ping time delay.

12. A method according to claim 10, wherein said resetting step includes initiating a new ping series having a new initial ping time delay that is different from the initial ping time delay.

13. A method according to claim 10, wherein said increasing or decreasing step includes varying each successive ping time delay from the immediately prior ping time delay.

14. A method according to claim 10, wherein said increasing or decreasing step includes allowing at least two immediately adjacent ping time delays to be the same.

15. A method according to claim 10, wherein said increasing or decreasing step includes a variation as a predetermined function of one or more input variables.

16. A method according to claim 10, further comprising:
identifying a termination event prior to or substantially simultaneously to accessing data from the remote computer; and
terminating the ping series in response to the termination event.

17. A method according to claim 10, further comprising:
identifying a reset event prior to or substantially simultaneously to accessing data from the remote computer; and
resetting the ping series in response to the reset event.

18. A system for requesting data from a remote computer, the system comprising:
means for initiating a ping series to the remote computer for accessing data from the remote computer, the ping series including a plurality of ping attempts each spaced by a ping time delay;
means for automatically increasing or decreasing the time of one or more of the ping time delays from an initial ping time delay across the ping series such that the ping time delay increases or decreases from the initial ping time delay over time;
means for resetting or terminating the ping series upon accessing data from the remote computer.

19. A machine readable medium containing machine executable instructions implementing a method of requesting data from a remote computer, the instructions comprising:
a set of instructions for transmitting a ping request for data to the remote computer;
a set of instructions for automatically successively transmitting additional ping requests for data to the remote computer spaced by time delays that vary according to a predetermined function from one successive time delay to another until a predetermined process event occurs.

20. A machine readable medium containing machine executable instructions implementing a method of requesting data from a remote computer, the instructions comprising:
a set of instructions for initiating a ping series to the remote computer for accessing data from the remote computer, the ping series including a plurality of ping attempts each spaced by a ping time delay;
a set of instructions for automatically increasing or decreasing the time of one or more of the ping time delays from an initial ping time delay across the ping series such that the ping time delay increases or decreases from the initial ping time delay over time;
a set of instructions for resetting or terminating the ping series upon accessing data from the remote computer.
